(19) United States
(12) Patent Application Publication
(10) Pub. No.: US 2007/0282718 A1
(43) Pub. Date: Dec. 6, 2007

(54) Stone cutting management system

(76) Inventors: Gary K. Morgan, Clear Lake, MN (US); Steve Fredrick Fuchs, Richmond, MN (US); Danny Dean Scott JR., Princeton, MN (US); Robert A. Penas, Silver Lake, MN (US); Martin Thomas Bruno, Foley, MN (US)

Correspondence Address: MERCHANT & GOULD PC, P.O. BOX 2903, MINNEAPOLIS, MN, 55402-0903, US

(21) Appl. No.: 11/803,935

(22) Filed: May 15, 2007

Related U.S. Application Data
(60) Provisional application No. 60/800,925, filed on May 15, 2006.

(51) Int. Cl. G06Q 10/00; G06F 7/00; G06Q 30/00; G08B 13/14

(52) U.S. Cl. 705/28; 340/572.1; 235/385; 700/225

(57) ABSTRACT

A stone cutting and finishing management system for managing an inventory of stone slabs is disclosed herein. The system includes a data management system with a database, an image station for creating a visual image of a slab from an inventory, each slab provided with a slab identifier, wherein the image and the identifier are stored in the database, a slab selection station with a visual display, a customer parts data file in the database including parts outline data, parts cutting data, and parts finishing data, a parts nesting system for displaying the parts outline data electronically on a selected slab image, a parts tagging station for projecting part outlines on the slab, wherein a part tag is attached to each part outline on the slab, a parts cutting station for cutting the parts from the slab in accordance with the data in the database, and a parts finishing station for providing a finishing process to the cut parts in accordance with the data in the database.

### CROSS REFERENCE TO RELATED APPLICATION

This application claims the benefit of provisional application Ser. No. 60/800,925, entitled COMBINED SAW AND WATERJET STONE CUTTING SYSTEM AND METHOD filed on May 15, 2006, the entire disclosure of which is incorporated herein by reference.

### TECHNICAL FIELD

The present disclosure relates generally to a stone cutting and shaping management system. More particularly, the present disclosure relates to a system for managing an inventory of natural or engineered stone slabs for use in cutting and shaping a selected stone slab into parts such as countertops.

### BACKGROUND

Currently, in the stone cutting industry, stone fabricators use a variety of methods and tools to measure the dimensions of a desired customer part such as a countertop to be installed and then transfer those dimensions to stone fabrication systems and machines utilized to cut and/or finish the edges of the stone. Often, the dimensions may be taken manually and then transferred manually to a stone slab for cutting the slab into desired parts. Plastic or wooden templates may be made of the desired parts and used on the slabs during the cutting process. This method creates potential for mistakes.

Moreover, the stone cutting industry is generally transitioning from manually edging the stone parts after they have been cut to utilizing CNC controlled machinery for such purposes. The CNC controlled machines are more accurate, repeatable, and reduce the amount of hand labor required. However, in order to utilize CNC controlled machines, the dimensions of the customer parts must be transferred to a computer generated CAD system. Stone fabricators are utilizing digitizing equipment that facilitates the process of measuring a desired customer part and transferring the data to a computer. This process makes it easier to input the data into a CAD system.

Additionally, stone fabricators that produce high volume have concerns of efficient material utilization as well as the ability to manage large numbers of work orders and parts through their facilities.

What is needed is a stone cutting management system that addresses the concerns and the needs described above.

### SUMMARY

One aspect of the present disclosure relates to a stone cutting and shaping management system for managing an inventory of stone slabs for use in cutting and shaping a selected stone slab into parts.

In one example embodiment, the stone cutting and shaping management system includes a data management system with a database, an image station for creating a visual image of a slab from an inventory of slabs, each of the slabs having a slab identifier, wherein the image and the identifier are stored in the database, a slab selection station with a visual display, a customer parts data file in the database including customer parts outline data, customer parts cutting data, customer parts finishing data, a parts nesting system for arranging and displaying the customer parts outline data electronically on a selected visual slab image, a parts tagging station for projecting part outlines on the slab, wherein a part tag is attached to each part outline on the slab, a customer parts cutting station for cutting the parts from the slab in accordance with the customer parts cutting data in the database, and a customer parts finishing station for providing a finishing process to at least one of the cut parts in accordance with the customer parts finishing data in the database.

Examples representative of a variety of inventive aspects are set forth in the description that follows. The inventive aspects relate to individual features as well as combinations of features. It is to be understood that both the forgoing general description and the following detailed description merely provide examples of how the inventive aspects may be put into practice, and are not intended to limit the broad spirit and scope of the inventive aspects.

### BRIEF DESCRIPTION OF THE DRAWINGS

FIG. 1 diagrammatically illustrates a stone cutting management system having features that are examples of inventive aspects in accordance with the principles of the present disclosure;

FIG. 2 illustrates a perspective view of an image station of the stone cutting management system of FIG. 1;

FIG. 3 illustrates a side view of the image station of FIG. 2;

FIG. 4 illustrates a front view of the image station of FIG. 2;

FIG. 5 illustrates a view screen from an example nesting program configured for use with the stone cutting management system of FIG. 1, the nesting program used for arranging and displaying customer part outlines electronically on a visual image of a slab produced by the image station of FIGS. 2-4;

FIG. 6 illustrates another view screen from the example nesting program illustrated in FIG. 5;

FIG. 7 illustrates a perspective view of a parts tagging station of the stone cutting management system of FIG. 1;

FIG. 8 illustrates a side view of the parts tagging station of FIG. 7;

FIG. 9 illustrates a front view of the parts tagging station of FIG. 7;

FIG. 10 illustrates a perspective view of an example cutting apparatus configured for use with the stone cutting management system of FIG. 1;

FIG. 11 illustrates a side view of the cutting apparatus of FIG. 10;

FIG. 12 illustrates a front view of the cutting apparatus of FIG. 10;

FIG. 13 illustrates a top view of the cutting apparatus of FIG. 10; and

FIG. 14 illustrates an example factory layout utilizing the stone cutting management system of FIG. 1.

### DETAILED DESCRIPTION

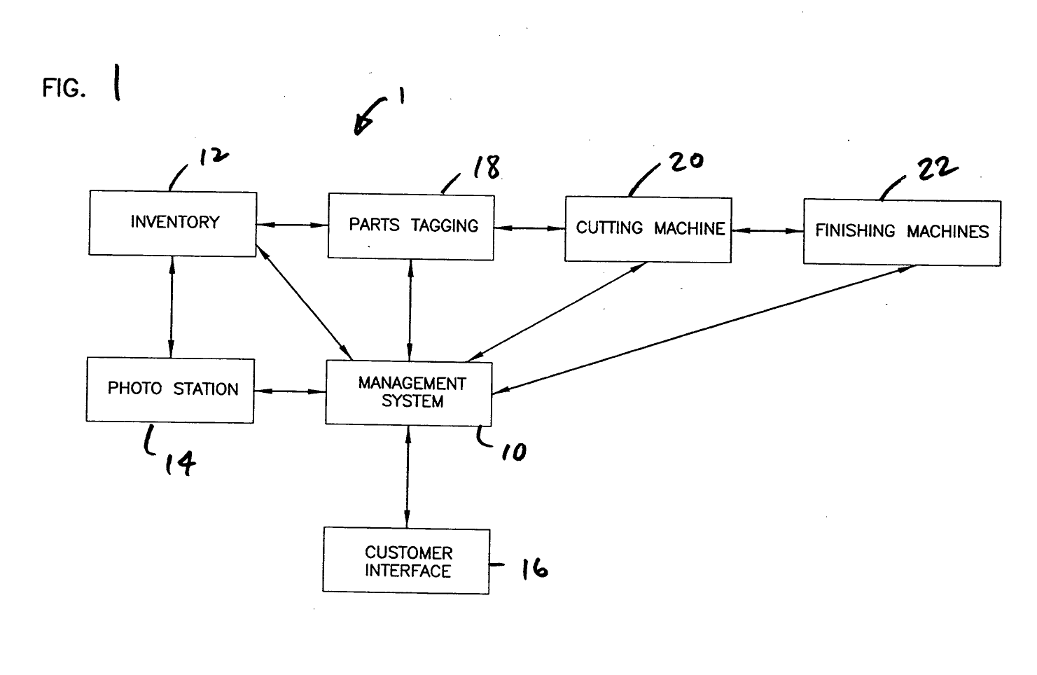

FIG. 1 illustrates a stone cutting and shaping management system 1 for managing an inventory of stone slabs 110 for use in cutting and finishing a selected stone slab 110 into desired parts such as countertops. The stone slabs 110 managed by system 1 may include natural stone slabs such as granite and marble or engineered stone slabs.

System 1 may be provided for cutting and finishing parts such as countertops from an inventory 12 of uncut stone slabs 110. System 1 includes a data management system 10 that is used to access inventory 12 and also to communicate with a customer interface 16 for selecting a slab 110 and cutting the desired parts from the selected slab 110. System 1 links the data management system 10 with the slab inventory 12, with an image (i.e., photo) station 14, with customer interface 16 (i.e., customer selection station), with a parts tagging station 18, with a customer parts cutting station 20 (e.g., including cutting apparatuses/machines) and with a customer parts finishing station 22 (e.g., including finishing apparatuses/machines).

The photo station 14 of system 1 is where images and/or data associated with each slab 110 in inventory 12 are visually recorded and entered. The images and data are sent to the data management system 10 for access at the customer interface 16 and for managing the slabs 110 throughout the process. Through the customer interface 16, a desired slab 110 may be selected from the inventory 12 and data associated with desired parts to be cut from the slab 110 may be entered into the data management system 10.

The parts tagging station 18 of system 1 can be used to individually tag each part to be cut on the slab 110 before cutting and processing the slab 110, as will be discussed in further detail below. Once the selected and tagged slab 110 is ready to be cut, a cutting apparatus at a cutting station 20 performs the cuts in accordance with the data associated with the desired parts to be cut. The cut parts may then be finished at the finishing station 22, such as for cutting faucet holes, edge finishes, etc. It should be noted that the parts can be tagged after they have been cut from the slab instead of beforehand, wherein the ID tags may be used for further processing operations downstream after cutting.

As will be discussed in further detail below, the data management system 10 may include a central database wherein a slab visual image and a slab identifier associated with that image may be recorded. The database may also include information associated with each part that is to be cut from a selected stone slab 110. Such information may be used to perform the cutting or finishing operations of the individual parts and also to keep track of the parts as the parts are routed through the system 1. Data relating to the individual parts may include data such as customer parts outline data, customer parts cutting data, and customer parts finishing data.

System 1 allows the entire process of managing slab inventory including deciding which slab to use, how the parts should be placed or laid out on the slab, how and where the parts will be cut, how and where the parts will be finished, as well as, how the work will be routed through a stone fabrication shop to be performed via a computer network. As will be described herein in further detail, via the stone cutting management system 1, the decision-making and the skill level required of the machine operators may be reduced. The entire slab inventory management can be performed by a decision maker in the office rather than on the shop floor. Via the system 1, the instructions for performing the cutting operations and the finishing operations can be sent to the appropriate machines and operators via the computer network. The status of the work, the location of the parts, and other data can be monitored as well via the computer network as a result of the system 1.

System 1 of the present disclosure may be suitable for a variety of sizes and sophistication of stone fabricators. The technology described herein may be applicable to small stone fabrication shops that perform a small number of jobs and move material manually as well as larger fabricators that may utilize automated material handling equipment and CNC controlled machines.

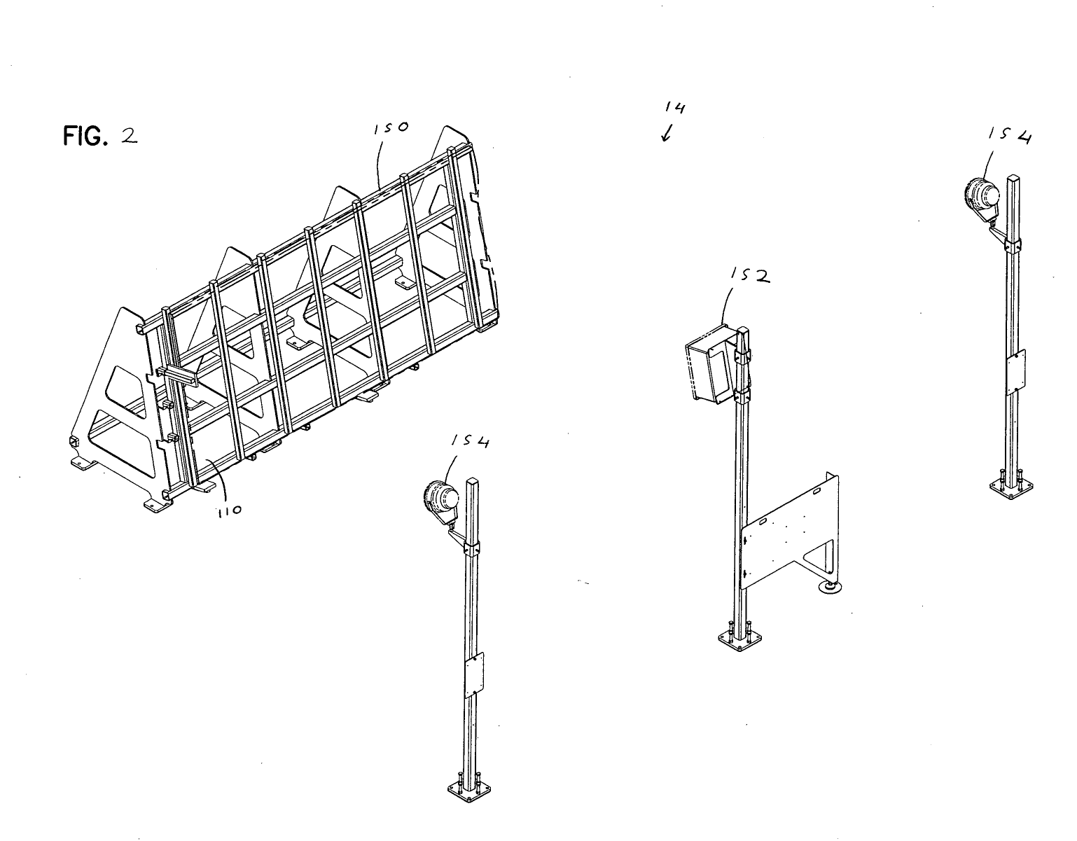

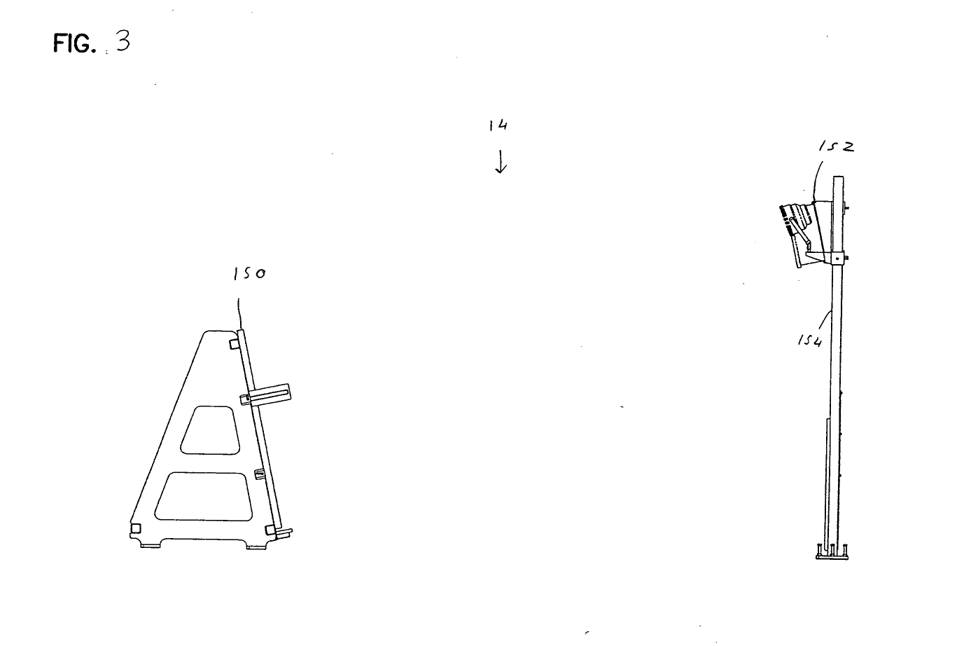

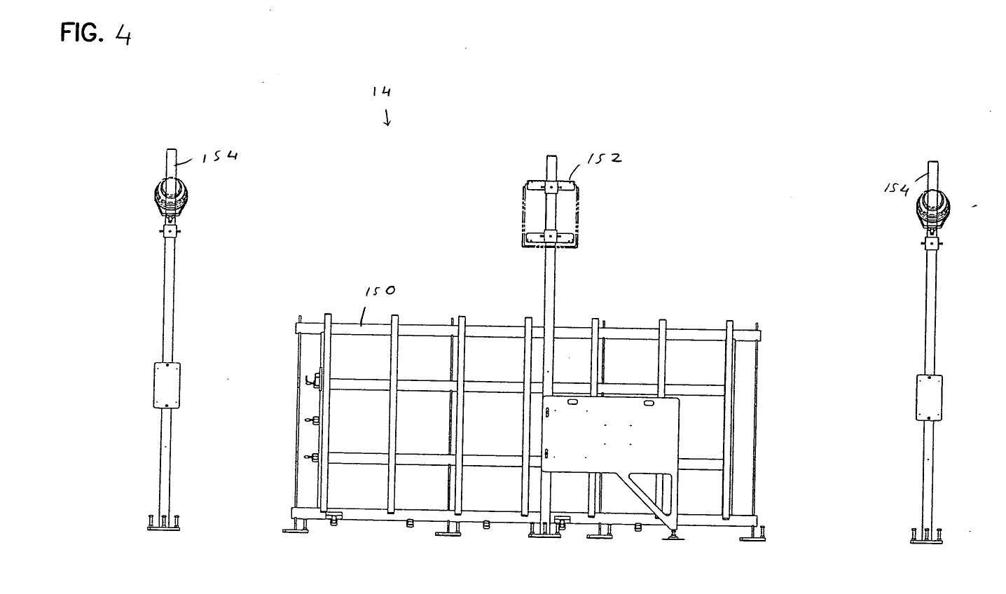

Referring now to FIGS. 2-4, the image (i.e., photo) station 14 of the system 1 is illustrated. The image station 14 is used for the transfer of electronic data of the slab 110 to the database that is part of the data management system 10. By creating a slab visual image representative of each of the slabs 110 from the entire inventory 12 and providing a slab identifying tag 200 having slab identifying information on the slab 110, a complete inventory of slabs 110 may be entered in the central database. The image station 14 allows for including a photo image of each slab 110 in the inventory 12 with flaws identified, as will be discussed in further detail below. By having all of the slabs 110 visually entered and tagged within the central database, the system 1 allows for the capability of pulling slab images from the central database and electronically nesting parts for the cutting processes. Once a photo is taken of a stone slab 110, an identifier tag 200 is placed on the slab 110. The slab identifier tag 200 may include information for identifying the slab 110 and associate the electronically stored image with the given slab. The slab identifier tag 200 may include identification devices such as a barcode, an RFID (Radio-frequency identification) tag, etc.

Once the image is taken of a slab 110, an inventory location is assigned for the slab 110 and that inventory location is associated with the slab identifier tag 200. In this manner, by searching the database, the image may be retrieved when desired and the inventory location of the part may be determined.

By having a photograph of the stone slab 110, a number of processes may be performed through the computer network. An available image of the slab 110 is used for nesting parts on the image of the slab 110 and visualize how the parts will look once finished. Customers can access the available inventory 12 and select a desired slab 110 that will suit their needs. If the slab 110 is customer supplied, the image can be used for nesting parts and keeping track of the slab 110 throughout the entire process.

During the image recording stage of the process, an operator may mark flaws on the slab 110 using a flaw marking input system such as a grease pen prior to taking the photo, if needed. The grease pen may preferably used for “hard to see” flaws. In this manner, when the photo is taken at the image station 14, the photo image will have flaws clearly marked. Preferably, the lighting and the picture quality used is such that the slab features are clearly visible with good color and accurate 1 to 1 scaling. Once a photograph is taken, it is digitally stored in the central database. Imperfections in the stone that are marked may include color variations, veins, flaws in the stone, cracks, etc. Some imperfections may be easy to see on an image and others that are more difficult to see may be marked with a grease pen, as noted above. The images may also be marked electronically on a visual image of the slab 110 once the image is recorded in the database.

In addition to the visual representation, other information about the slab 110 can be stored in the database. Slab data may include a complete description of the slab 110, allowing the user to define all the required elements for processing and tracking. The exact type of data to be stored for each slab 110 could vary with each customer.

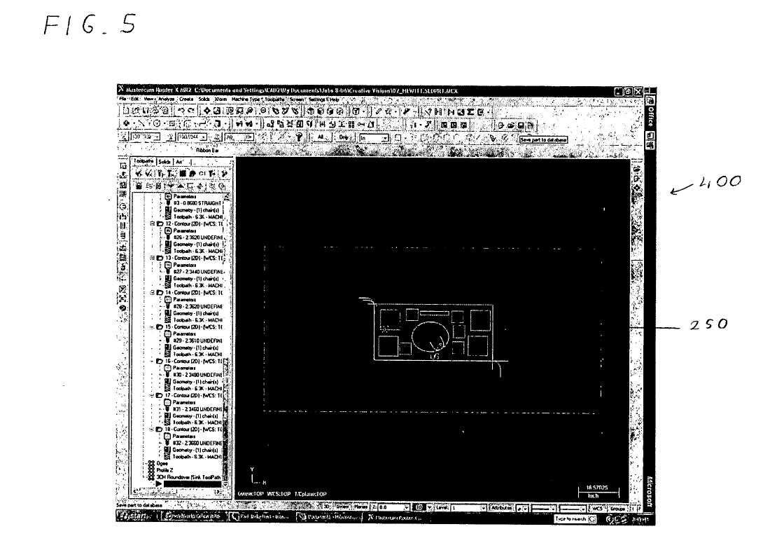

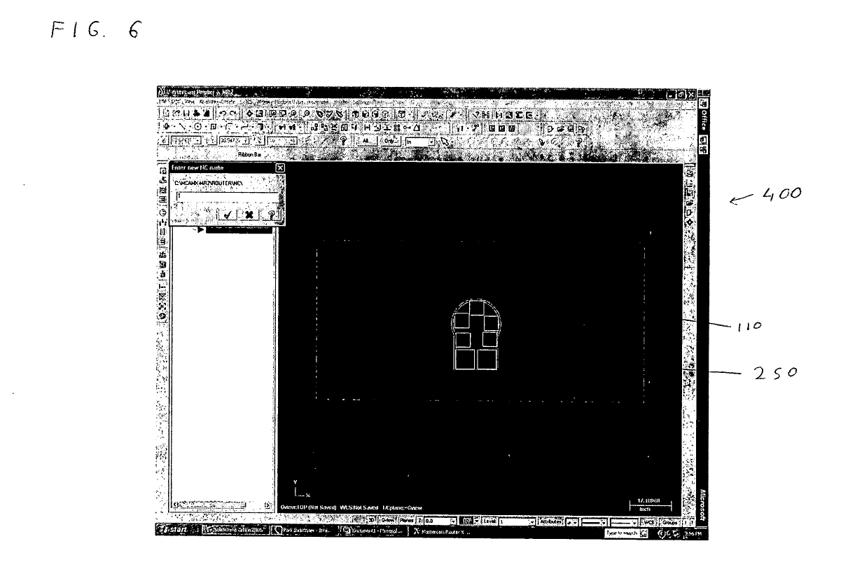

As noted previously, slab data stored in the central database may be used (including the marked flaws) for the purpose of nesting parts outlines 250 onto the slab 110 using nesting software 400. The nesting software 400 may be used for arranging and displaying customer part outlines 250 electronically on the visual image of a slab 110 produced by the image station 14. FIG. 5 illustrates a view screen from an example nesting program 400. The view screen illustrated in FIG. 5 shows part outlines 250 that are to be cut for a customer. FIG. 6 illustrates another view screen from the example nesting program 400. In FIG. 6, the part outlines 250 are illustrated in a nested configuration on the selected slab 110. Once nesting is done, these parts are tagged individually and cut from the slab 110 with a cutting apparatus, as will be discussed in further detail below.

Referring back to FIGS. 2-4, a station frame 150 of the image station 14 is configured to hold the slab 110 in a vertical position and at such an angle as to insure the safety of the operator. The, image station 14 includes a fixture for holding a camera 152 in a fixed position and at a fixed angle to ensure perpendicularity with the slab 110 being photographed. Lighting is provided, as required, to take a good quality picture. According to one example image station 14, the station frame 150 may be sized such that the slab sizes that are visually recorded at the image station 14 may have a minimum size of about 18 inches by 26 inches and a maximum size of about 84 inches by 144 inches.

In using an image station 14 with the stone cutting management system 1, a PC with a graphics feature is preferred. Such a PC may run with 120 VAC power at 3 amps. The image station 14 may also include a barcode printer and a barcode scanner that may run with 120 VAC power at 4 amps for slab tagging purposes.

In tagging the slabs 110, identifiers such as barcodes may have zones. One zone may be for positioning on a top of the slab 110, one for positioning on the bottom, and one on the edge. In this manner, the slab 110 may be scannable from three different sides.

According to one example, the lighting used may be 4000 watt lighting and run with 240 VAC at 17 amps. Transformer to 120 VAC may be used for photo lighting equipment. Lighting may vary as location of the photo station varies. In one embodiment, the camera may have a fixed focal length.

Referring back to FIGS. 5 and 6, examples of the parts nesting system 400 of the system 1 are illustrated. Once electronic customer parts outlines 250 are created and stored in the central database, these outlines/drawings 250 may be used to nest the parts on the stored image of the stone slab 110. As shown in FIG. 6, during nesting, the entire outline of a slab 110 is highlighted to make sure parts do not get nested out of the workable surface of the slab 110. Although in the depicted embodiment of the system, automated nesting software 400 can be used, it should be noted that the nesting may be performed manually. Manually created templates may be placed on the slab 110 to visually see the parts on the slab.

Automated nesting provides certain advantages such as customer interaction and remote management. During nesting, marked or unmarked flaws may be avoided. By nesting, material utilization is optimized. Appearance of the grain may be visualized and optimized. Pattern matching may be performed. Once a visual representation of the nested slab 110 is obtained, the image can be sent to the customers for approval. By nesting, the ability to visualize how the finished product will appear in the customer's installation is greatly enhanced. Automated nesting may provide certain advantages over manual nesting and alter certain aspects of a conventional manual nesting procedure such as who is performing the nesting operation, the ease by which the nesting operation is performed, and how the nested image may facilitate downstream operations.

Once a slab 110 has been nested, engineering drawings (e.g., in DXF file format) may be generated of the nested parts and information associated with each part may be entered into the central database. Such information may include machine instructions associated with the cutting and finishing of the parts, location of the parts, the tools associated with the machine instructions, etc. An operator, such as a CAD-CAM system operator, may assign the tools and the edges that are put on the edging machine 22 as well as determine the processes for cutting by generating machine instructions that are sent to the machines.

Once the operations associated with each part is entered into the central database, the parts may be physically tagged on the slab 110, wherein each part receives a part tag (i.e., ID tag) 300 that ties all of the processes associated with that part to the physical part. Each part gets its own individual ID tag 300 that ties it to a work order. For example, the ID tags 300 may be associated with which machines will be used to cut and finish the parts, the instructions to perform all of the operations on the parts, and other types of information about the parts. The ID tags 300 may be used to communicate the job to the appropriate workcenter that may include CNC type machines. The file associated with each part gets downloaded into the appropriate machines for each part and pulled up in accordance with the part ID tag 300. It should be noted that the parts can be tagged after they have been cut from the slab, wherein the ID tags may be used for further processing operations downstream of the cutting.

Once an engineering drawing of the nested slab 110 and the parts are created and all of the information associated with each of the parts are entered into the central database, the parts are physically tagged on the slab 110 or after they have been cut off the slab. The tag 300 on each part is used to link the part with the processes associated with that part in the database.

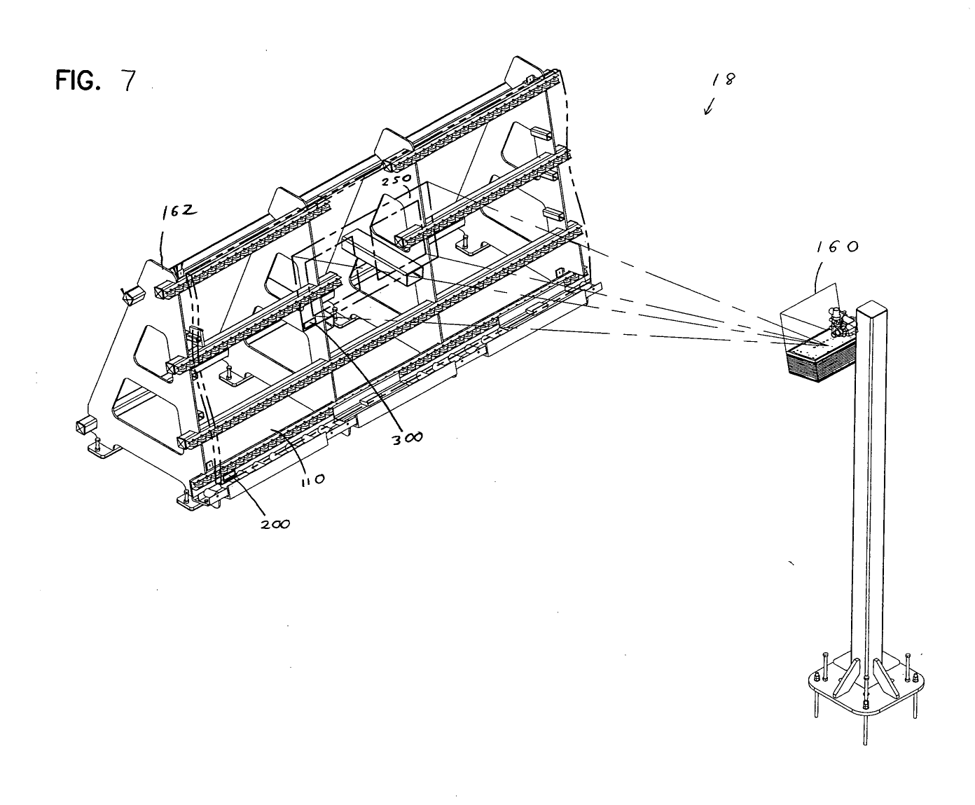

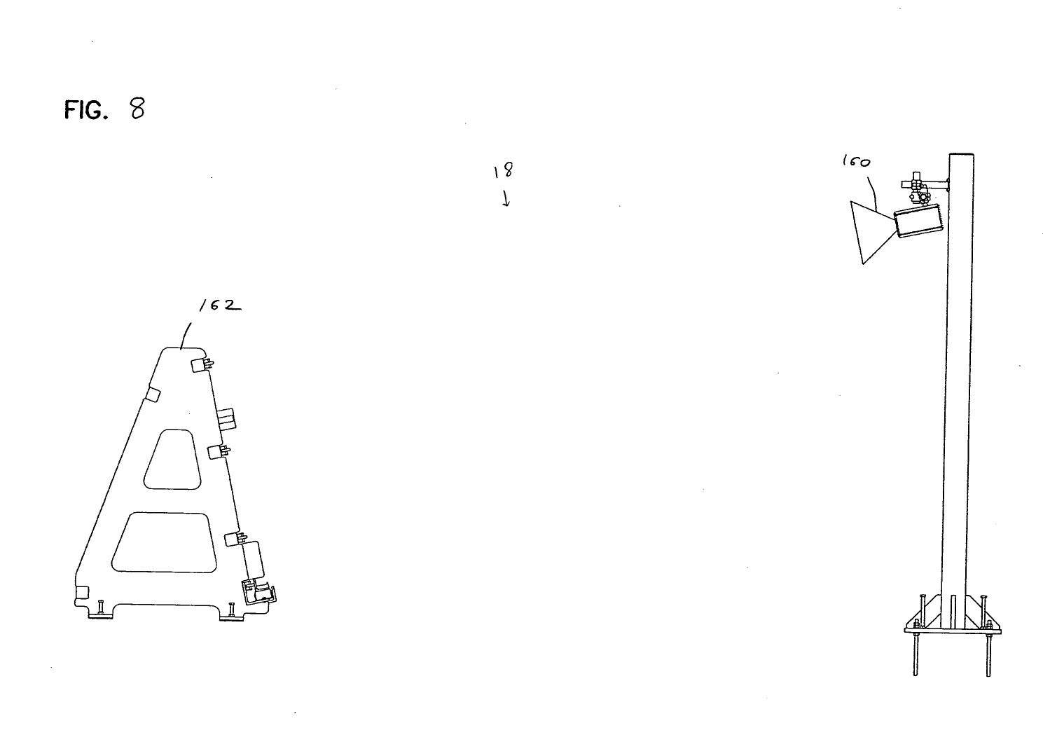

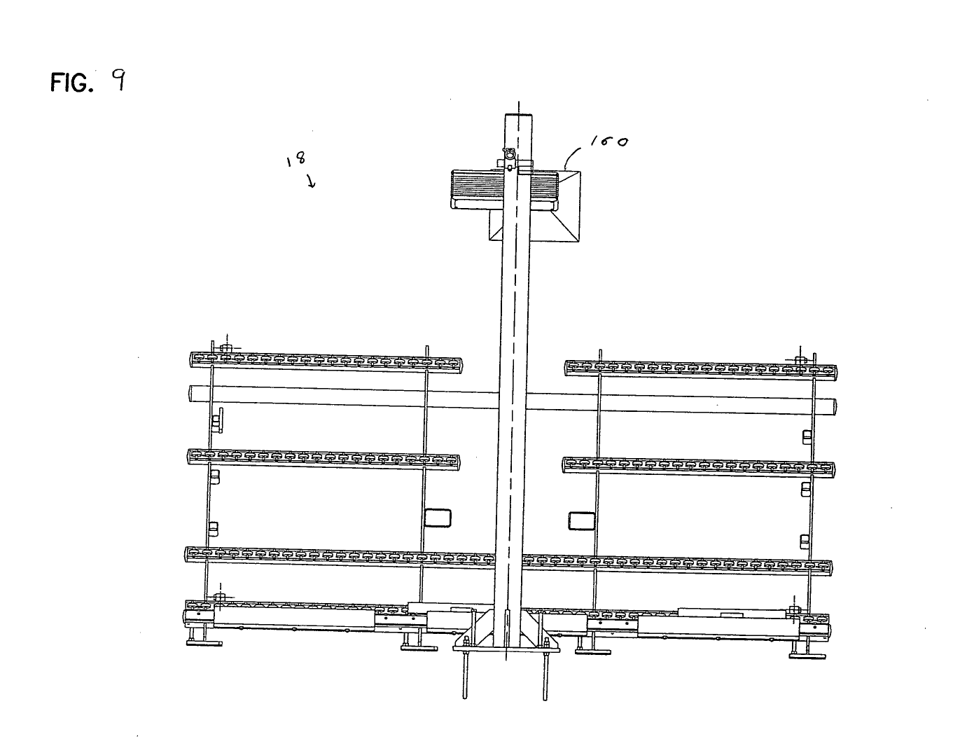

Referring now to FIGS. 7-9, the parts tagging station 18 of the system I is illustrated. In one embodiment, the tagging station 18 can show an operator the location of parts before they are cut from the slab 110. A laser 160 may be used to display visual images of each of the parts on the slab 110 held in frame 162 for viewing by the operator. The image can include a part outline 250, as shown in FIG. 7. Operator can add a tag 300 to each part to identify the part and to provide information for further processing at stations downstream of the cutting station. As shown in FIG. 7, each part gets its own tag 300 in addition to the tag 200 that was previously placed on the slab 110 for keeping track of the slab. As in the slab identifier tag 200, the ID tag 300 for the parts may be a barcode, an RFID tag, etc.

A barcode and an RFID tag may each have unique advantages over the other. Which one will be utilized may depend upon the part and the processes to be performed for the part. For example, by using a barcode, a visual image of the part may be printed out and appear on the tag 300. By using an RFID tag, the identifier information of the identifier tag 300 may be scanned/read from an opposite side of the stone.

The ID tag 300 on each individual part is matched up with a work order for that part, as indicated above. The ID tags 300 may be used to cut the parts and finish the parts. The file associated with each part gets downloaded into the appropriate machines or apparatuses based on the scanned ID tag 300. The operators may scan the ID tag 300 after a job is done as being finished.

The ID tags 300 on the parts are used throughout the entire process. The ID tags 300 are used to determine the parts and their locations. Previously created machine instructions for, for example, CNC controlled machines, that may include the tools are communicated as “jobs” to the appropriate workcenters. The ID tags 300 are used to facilitate part status and tracking by assigning routings for work orders or jobs. They may even be used to communicate and send instructions to automated material handling systems (e.g., automated transport systems), if utilized.

The tagging of the parts and associating operating processes with the tags 300 may provide a number of other advantages. For example, according to one example, the machine stations 20, 22 may be equipped to project a laser image of the parts during the cutting or finishing of the parts such that operators can have a visual image of the parts during, for example, loading, cutting, or finishing operations. The laser projections may be used either on the slabs 110 during the loading and cutting operations or on the individual parts during the finishing processes. For example, when the parts are being loaded for a finishing process, the laser projection outline is used to match the edges of the part to the projection so that an operator will know the part is being loaded in the correct orientation. The laser projection image may be tied to the ID tag for the slab or for each part.

Once the selected and tagged slab 110 is ready to be cut, a cutting apparatus at a cutting station 20 performs the cuts in accordance with the data associated with the desired parts to be cut. It should be noted that a variety of different cutting apparatuses may be used with the system 1. The cutting apparatus may be as simple as a manually operated saw or as complex as a fully automated CNC controlled machine.

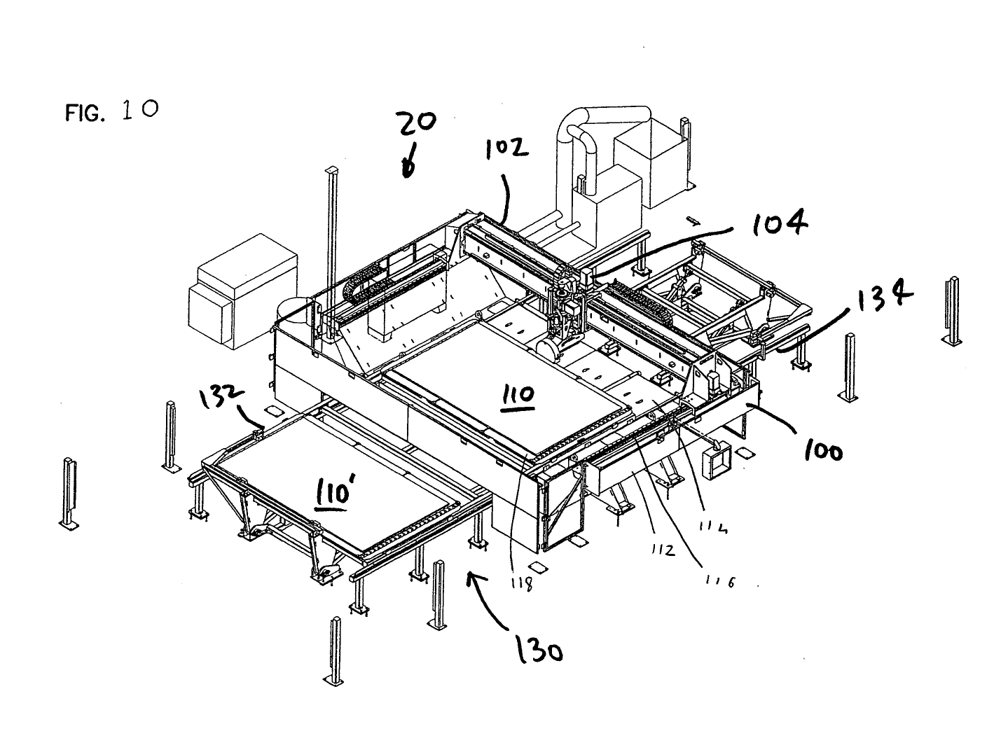

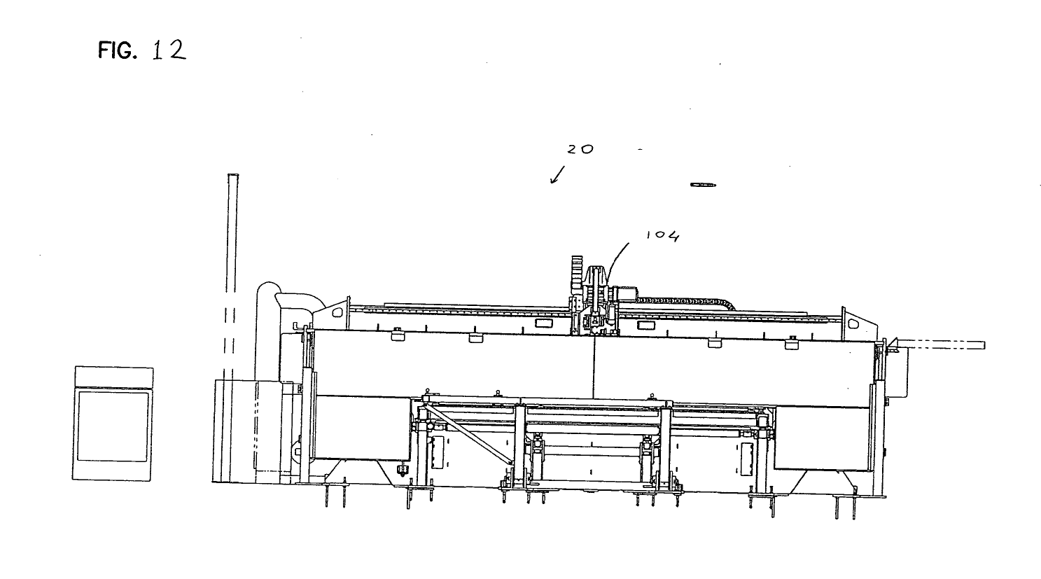

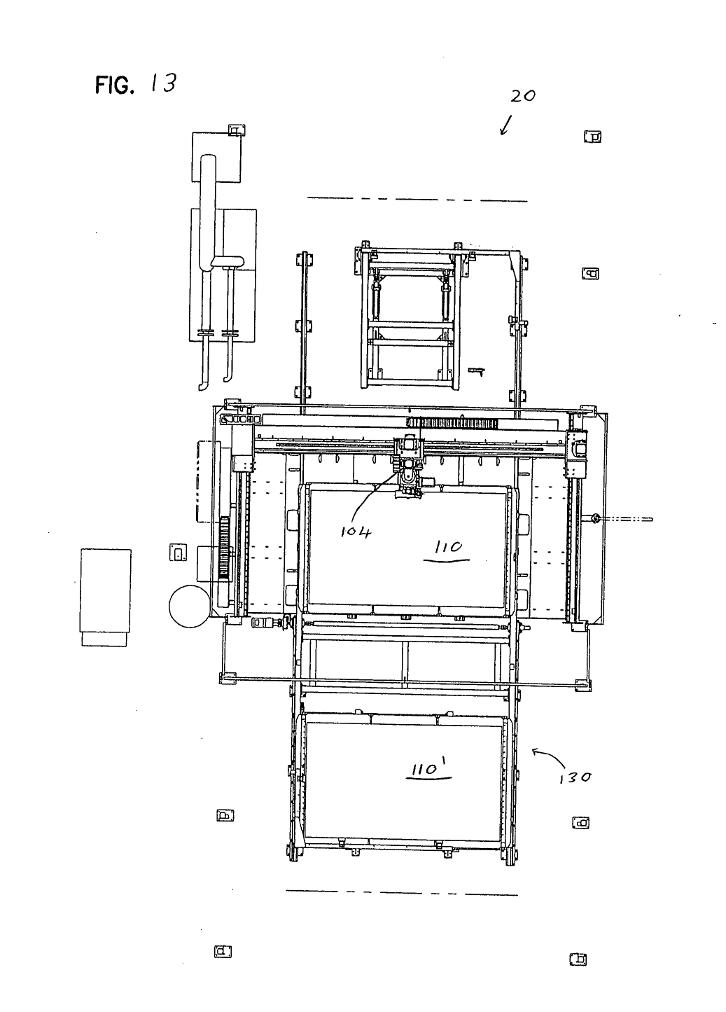

A non-limiting example of a cutting apparatus that may be used with the system 1 is shown in FIGS. 10-13. The cutting apparatus illustrated in FIGS. 10-13 combines in a single station two cutting heads for cutting the various parts from the selected slab. The cutting apparatus includes a rotary tool, such as a circular saw, for cutting linear lines. A waterjet provided on the same apparatus is configured to cut curves and the desired final cuts between linear segments.

Still referring to FIGS. 10-13, the cutting apparatus 20 includes a frame 100 and a moveable beam 102. Positioned on moveable beam 102 is a moveable head or carriage 104. Carriage 104 includes the rotary saw 106 and the waterjet 108. Carriage 104 moves along beam 102. Beam 102 moves along frame 100 in a cross direction to the movement of carriage 104. In this manner, rotary saw 106 and waterjet 108 can be moved relative to slab 110 for the desired cuts. Saw 106 is vertically movable independently of waterjet 108 which can also be moved vertically toward and away from the slab 110.

A water tank 112 is positioned below cutting area 114. Slab 110 is supported by a grid 116. Positioned between grid 116 and slab 110 may be a spoil board 118, such as wood. The saw 106 is configured to cut into spoil board 118, but not into the grid 116.

In the depicted example, the cutting apparatus 20 may include a shuttle system 130 for shuttling slabs 110 into and out of cutting area 114. While one slab is being cut, a second slab 110′ can be loaded at end 132. Once cut, the cut parts from slab 110 are moved to end 134. Then a new slab can be loaded.

The depicted example of the cutting apparatus 20 is configured to cut naturally formed stones such as granite and also engineered stones. The cutting apparatus is configured to cut stones having a thickness of about 2 centimeters to about 6 centimeters. The cutting apparatus is configured to cut slabs having dimensions of about 7 feet by 12 feet. The depicted cutting apparatus may have a positioning accuracy of ±0.005.

The rotary tool is designed to saw at all angles and the waterjet is designed to cut curved parts and finish saw cuts. The cutting apparatus preferably performs “common line” cutting whereby the sawn edge of one part is the same edge of an adjacent part.

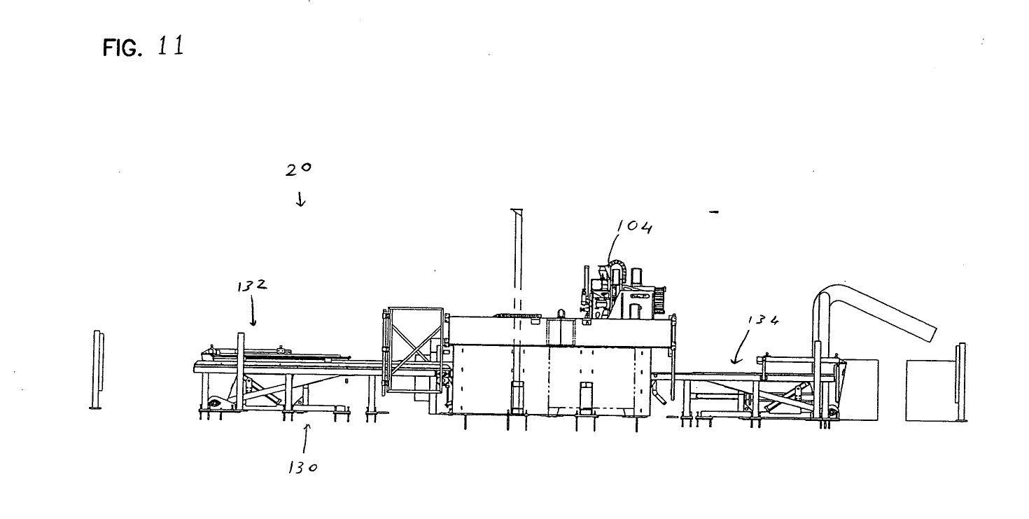

As discussed above, in the depicted cutting station, shuttle tables may shuttle in and out of the machine for loading and unloading slabs. Each shuttle table has a rotating lift station to allow for the loading of the slab 110 in a vertical position (see FIGS. 10 and 11).

The depicted cutting apparatus may have an X-axis (i.e., bridge travel) maximum speed of about 2000 inches per minute. The depicted cutting apparatus may have a Y-axis (i.e., head cross-travel) maximum speed of about 2000 inches per minute. The depicted cutting apparatus may have a Z-axis (i.e., in/out of stone travel) maximum speed of about 500 inches per minute. The rotary tool of the cutting apparatus may have a pivoting feature wherein the maximum speed of the pivoting swivel would be about 60 revolutions per minute.

As noted above, the cutting apparatus may include X-axis travel (i.e., bridge travel) to have cutting coverage to encompass one slab of granite 12 feet in length. The cutting apparatus may also include Y-axis travel to have both heads cutting coverage to encompass one slab with a width of 7 feet. The cutting apparatus may also include Z-axis travel that is configured to cover maximum material thickness plus 1.5 inches on either side of the material. As noted above, the cutting apparatus depicted herein has a swivel C-axis travel of ±180 degrees. The pivot mechanism may be powered by a motor having about 20 horsepower.

In one embodiment, the waterjet portion of the cutting apparatus depicted herein is driven by a 50 horsepower hydraulic pump that creates a 55,000 PSI system. The cutting apparatus includes high pressure plumbing from the pump to the high pressure nozzle. The waterjet portion may also use abrasives as known in the art for facilitating cutting. With such a feature, the cutting apparatus may include an abrasive cleaning system for continuous cleaning of the tank.

Regarding the electrical features of the cutting apparatus, the cutting apparatus may be controlled by a CNC controller having a stand alone floor mounted cabinet. AC servo drives may provide gantry travel (Y, Y′), cross travel (X), rise and fall motion (Z), and swivel head travel (C).

According to one embodiment, the cutting apparatus may accommodate supply voltages of 208, 240, 480, 575 volts. The cutting apparatus may include barcode or RFID reading with program download capability. As discussed previously, a barcode or RFID tag 300 may be used to identify each part on the slab prior to the cutting operation. If an RFID type of a part identifier tag 300 is used, an RFID station may be provided to tag each part prior to being processed by the cutting apparatus.

In operation of the cutting apparatus, an operator may place the slab 110 onto the table. The operator may then scan in the slab barcode or RFID tag 300. The cutting apparatus is configured to select the proper DXF file and the MC9 tool path file from the central database. The operator sets the slab 110 on locators when loading on the table pallet. The operator initiates lowering of the table pallet and pushes a user control switch that indicates that the table is loaded and ready for processing. This allows for the advancement of the table into the cutting area of the apparatus. Once the slab 110 is cut, the other table will be ready to be loaded.

The cutting apparatus may provide for a modem connection that may provide for a customer required analog phone line and allow for remote diagnostic troubleshooting.

The cutting apparatus may also include a number of safety features such as emergency brakes, light curtains, etc., as known in the art.

After the parts are cut, the cut parts may then be finished at a finishing station 22 by a variety of different apparatuses such as polishing machines, edge shapers, etc. Two example finishing apparatuses that are suited for use with the system 1 are available from Park Industries® under model names FASTBACK™ Flat-Edge Polishing Machine and VELOCITY Decorative Edge Shaper & Polisher.

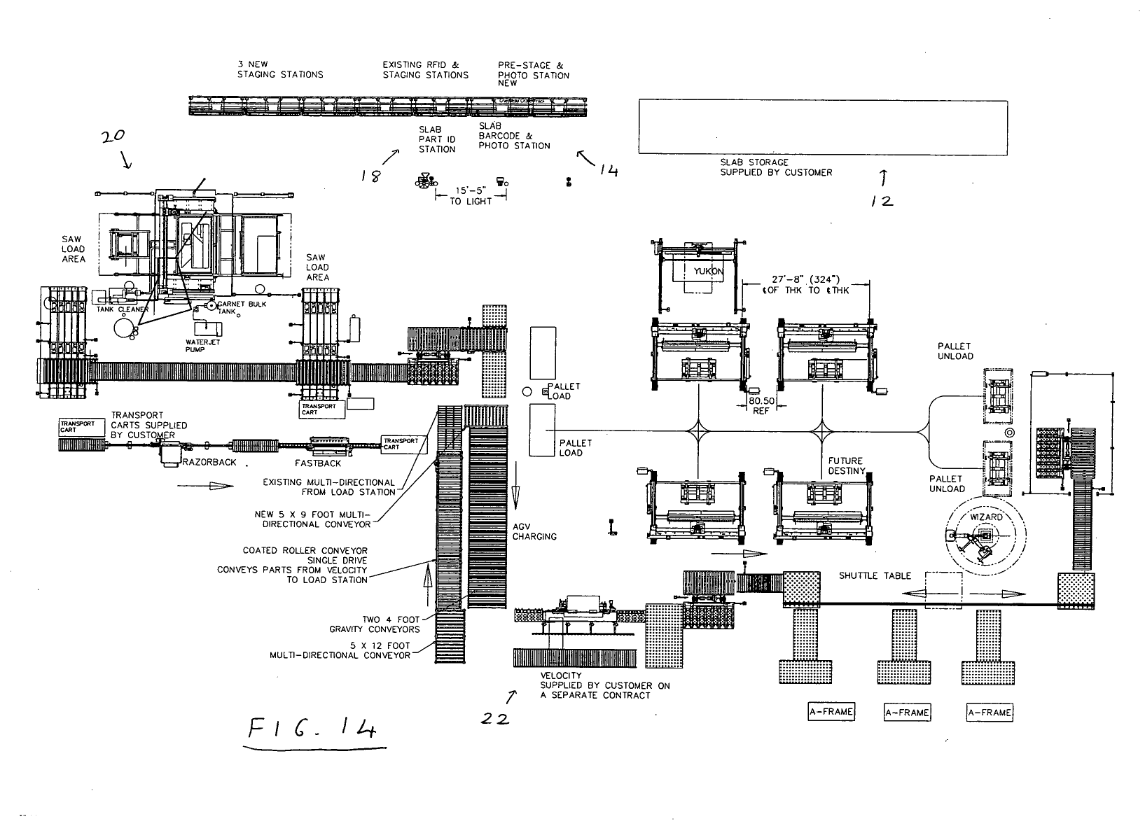

FIG. 14 illustrates an example factory layout utilizing the stone cutting management system 1.

As noted previously, the process for moving or loading cut parts across the floor may be done in an automated manner using automated carts. The ID tags 300 on the parts may be used to link the parts with the associated transport processes.

The system 1 of the present disclosure facilitates part identification and instructions for disposition for scrap, rework, and shipment. The system 1 facilitates sending messages and instructions to various work centers for materials moving and instructions for processing. The system 1, by using a computer network, facilitates work order management and metrics by utilizing an integrated reporting system. The system 1 locates decision-making to the office rather than leave it to operator judgment. With the system 1, experience level required for producing parts can be reduced since the decision-making occurs at the office level and processing of parts through the floor is automated. Machine operators can focus on operating the machines rather than on other aspects.

Even though the cutting, finishing and transporting processes are described herein as being automated by downloading the associated files, in other embodiments of the system 1, all or a part of the processes can be performed manually. Even if a number of the processes are performed manually, stations such as the image station 14 or the parts tagging station 18 may still be used to capture a visual image of the slab electronically and track the slab inventory and the parts through the floor. Even if all of the cutting, finishing, and transporting processes are performed manually, the system described herein may still include features that allow for computer based customer interaction, customer selection, and digital visualization of the parts, among other features.

The above specification provides examples of how certain inventive aspects may be put into practice. It will be appreciated that the inventive aspects can be practiced in other ways than those specifically shown and described herein without departing from the spirit and scope of the inventive aspects.

We claim:

1. A stone cutting and finishing management system for managing an inventory of stone slabs for use in cutting and finishing a selected stone slab into parts, comprising:
A) a data management system including a database;
B) an image station for creating a slab visual image representative of each of a plurality of stone slabs from an inventory of stone slabs, each of the stone slabs having a slab identifier tag with a slab identifier, wherein the slab visual image and the slab identifier are stored in the database of the data management system and wherein the image station includes a flaw marking input system for marking flaws on the slab visual image;
C) a selection station for selecting one of the stone slabs from the inventory of stone slabs, wherein the selection station includes a visual display for viewing the selected slab visual image;
D) a customer parts data file in the database of the data management system including customer parts outline data, customer parts cutting data, customer parts finishing data;
E) a parts nesting system for arranging the customer parts outline data and displaying the customer parts outline data electronically on the selected slab visual image to confirm all of the parts fit, wherein the parts nesting system includes a visual display for electronically viewing the selected slab visual image and parts outlines;
F) a parts tagging station for projecting part outlines from the customer parts outline data on the selected stone slab, wherein a part tag is attached to each part outline on the selected stone slab;
G) a customer parts cutting station for cutting the parts from the selected stone slab, wherein the customer parts cutting station is controlled by the customer parts cutting data in the database of the data management system; and
H) at least one customer parts finishing station for providing a finishing process to at least one of the cut parts, wherein the customer parts finishing station is controlled by the customer parts finishing data in the database of the data management system.

2. The management system of claim 1, further comprising:
a slab identifier tag scanning station for reading the slab identifier tag before the selected stone slab is cut into parts at the customer parts cutting station and
a part tag scanning station for reading the part tag of each part before each part is processed by the customer parts finishing station.

3. The management system of claim 1, wherein the slab identifier tag and the part tag include barcodes.

4. The management system of claim 1, wherein the slab identifier tag and the part tag include Radio-frequency identification.

5. The management system of claim 1, wherein at least one of the customer parts cutting station and the customer parts finishing station includes CNC controlled machinery.

6. The management system of claim 5, wherein the CNC controlled machinery includes two cutting heads, wherein one of the heads is a rotary tool and the other head is a waterjet.

7. The management system of claim 1, wherein the parts nesting system utilizes nesting software.

8. The management system of claim 1, wherein the flaw marking input system includes a grease pen.

9. A method of managing an inventory of stone slabs for use in cutting and finishing a selected stone slab into parts, comprising:
A) providing a data management system including a database;
B) creating a slab visual image representative of each of a plurality of stone slabs from an inventory of stone slabs, each of the stone slabs having a slab identifier tag with a slab identifier, wherein the slab visual image and the slab identifier are stored in the database of the data management system;
C) selecting one of the stone slab visual images from the database;
D) creating a customer parts data file in the database of the data management system including customer parts outline data, customer parts cutting data, customer parts finishing data;
E) arranging the customer parts outline data and displaying the customer parts outline data electronically on the selected slab visual image to confirm all of the parts fit;
F) projecting part outlines from the customer parts outline data on the selected stone slab, wherein a part tag is attached to each part outline on the selected stone slab;
G) cutting the parts from the selected stone slab using the customer parts cutting data in the database of the data management system; and
H) finishing the parts using the customer parts finishing data in the database of the data management system.

10. A method according to claim 9, further comprising scanning the slab identifier tag before the selected stone slab is cut into parts and scanning the part tag of each part before each part is finished.

11. A method according to claim 9, wherein the slab identifier tag and the part tag include barcodes.

12. A method according to claim 9, wherein the slab identifier tag and the part tag include Radio-frequency identification.

13. A method according to claim 9, further comprising at least one of cutting the parts using CNC controlled machinery or finishing the parts using CNC controlled machinery.

14. A method according to claim 13, wherein the CNC controlled machinery includes two cutting heads, wherein one of the heads is a rotary tool and the other head is a waterjet.

15. A method according to claim 9, further comprising using nesting software for arranging the customer parts outline data and displaying the customer parts outline data electronically on the selected slab visual image.

16. A method according to claim 9, further comprising marking flaws on the slab visual image.

17. A stone cutting management system for cutting and finishing a stone slab into parts, comprising:
A) a data management system including a database;
B) an image station for creating a slab visual image representative of a stone slab, the stone slab having a slab identifier tag with a slab identifier, wherein the slab visual image and the slab identifier are stored in the database of the data management system;
C) a customer parts data file in the database of the data management system including customer parts outline data, customer parts cutting data, customer parts finishing data;
D) a parts nesting system for arranging the customer parts outline data and displaying the customer parts outline data electronically on the slab visual image to confirm all of the parts fit, wherein the parts nesting system includes a visual display for electronically viewing the slab visual image and parts outlines;
E) a parts tagging station for projecting part outlines from the customer parts outline data on the stone slab, wherein a part tag is attached to each part outline on the stone slab;
F) a customer parts cutting station for cutting the parts from the stone slab, wherein the customer parts cutting station is controlled by the customer parts cutting data in the database of the data management system; and
G) at least one customer parts finishing station for providing a finishing process to at least one of the cut parts, wherein the customer parts finishing station is controlled by the customer parts finishing data in the database of the data management system.

18. A stone cutting and finishing management system for managing an inventory of stone slabs for use in cutting a selected stone slab into parts, comprising:
A) a data management system including a database;
B) an image station for creating a slab visual image representative of each of a plurality of stone slabs from an inventory of stone slabs, each of the stone slabs having a slab identifier tag with a slab identifier, wherein the slab visual image and the slab identifier are stored in the database of the data management system and wherein the image station includes a flaw marking input system for marking flaws on the slab visual image;
C) a selection station for selecting one of the stone slabs from the inventory of stone slabs, wherein the selection station includes a visual display for viewing the selected slab visual image;
D) a customer parts data file in the database of the data management system including customer parts outline data, customer parts cutting data, customer parts finishing data;
E) a parts nesting system for arranging the customer parts outline data and displaying the customer parts outline data electronically on the selected slab visual image to confirm all of the parts fit, wherein the parts nesting system includes a visual display for electronically viewing the selected slab visual image and parts outlines;
G) a customer parts cutting station for cutting the parts from the selected stone slab, wherein the customer parts cutting station is controlled by the customer parts cutting data in the database of the data management system; and
H) at least one customer parts finishing station for providing a finishing process to at least one of the cut parts, wherein the customer parts finishing station is controlled by the customer parts finishing data in the database of the data management system.

19. A stone cutting and finishing management system according to claim 18, further comprising a parts tagging station, wherein a part tag is attached to each part cut from the selected stone slab.

20. A stone cutting and finishing management system for managing an inventory of stone slabs for use in cutting and finishing a selected stone slab into parts, comprising:
A) a data management system including a database;
B) an image station for creating a slab visual image representative of each of a plurality of stone slabs from an inventory of stone slabs, each of the stone slabs having a slab identifier tag with a slab identifier, wherein the slab visual image and the slab identifier are stored in the database of the data management system and wherein the image station includes a flaw marking input system for marking flaws on the slab visual image;
C) a selection station for selecting one of the stone slabs from the inventory of stone slabs, wherein the selection station includes a visual display for viewing the selected slab visual image;
D) a customer parts data file in the database of the data management system including customer parts outline data;
E) a parts nesting system for arranging the customer parts outline data and displaying the customer parts outline data electronically on the selected slab visual image to confirm all of the parts fit, wherein the parts nesting system includes a visual display for electronically viewing the selected slab visual image and parts outlines; and
F) a parts tagging station for projecting part outlines from the customer parts outline data on the selected stone slab, wherein a part tag is attached to each part outline on the selected stone slab.
